(19) United States
(12) Patent Application Publication
(10) Pub. No.: US 2009/0327916 A1
(43) Pub. Date: Dec. 31, 2009

(54) APPARATUS AND METHOD FOR DELIVERING TARGETED CONTENT

(75) Inventor: Daniel R. Baran, Mill Valley, CA (US)

Correspondence Address: NIXON PEABODY, LLP, 401 9TH STREET, NW, SUITE 900, WASHINGTON, DC, 20004-2128, US

(73) Assignee: CBS INTERACTIVE, INC., Wilmington, DE (US)

(21) Appl. No.: 12/268,347

(22) Filed: Nov. 10, 2008

Related U.S. Application Data
(60) Provisional application No. 61/076,464, filed on Jun. 27, 2008.

(51) Int. Cl. G06F 3/048

(52) U.S. Cl. 715/745

(57) ABSTRACT

An intelligent commerce module is described that provides a contextual based commerce experience by: (1) determining the context under which a user wishes to acquire an asset; (2) determining the context under which the asset is being offered; and, (3) delivering a buying experience appropriate for the user and the context under which the asset is being offered.

### CROSS-REFERENCE TO RELATED APPLICATIONS

This application claims the benefit of U.S. Provisional Application No. 61/076,464, filed Jun. 27, 2008, entitled “Intelligent Commerce Module,” the entirety of which is hereby incorporated by reference.

### BACKGROUND

1. Field

The subject invention relates to a system and method for providing targeted content to a user based on a context of the user's browsing experience.

2. Related Art

The Internet is a network of computers linked together by various communication links running TCP/IP (transmission control protocol/Internet protocol). These computers have browsers that allow a GUI (graphical user interface) to be used so that the computers can communicate over the Internet. The GUIs also allow users of the computers to create web pages and web sites (i.e., collections of web pages) that are stored on an Internet web server. Other users can then access a web page from the Internet web server using their own browser.

The Internet is often used by users for shopping (i.e., the purchase of goods, services, products, downloads and other assets). Web pages offered by merchants allow users to view the merchant's assets for sale and purchase the assets through the web page. These merchants typically include manufacturers of the assets, retailers, and the like. The Internet is also used to locate information, such as news, information regarding hobbies, reviews of assets, and so on.

Many online merchants and manufacturer's also advertise on these information-oriented web pages. For example, a digital camera manufacturer or a retailer of the digital camera may advertise on a news website because of the large number of Internet users and the diversity of the Internet users who access news information from that news website. These advertisements often include links to the web page where the asset being advertised can be acquired. This method of offering assets for sale and advertising provides only one method for the user to acquire the given asset, regardless of the user, asset, relationships among manufacturer, retailer and initiating party (e.g., news website), etc.

### SUMMARY

The following summary is included in order to provide a basic understanding of some aspects and features of the invention. This summary is not an extensive overview of the invention and as such it is not intended to particularly identify key or critical elements of the invention or to delineate the scope of the invention. Its sole purpose is to present some concepts of the invention in a simplified form as a prelude to the more detailed description that is presented below.

According to an aspect of the invention, a method for delivering targeted content comprising is provided. The method includes parsing content accessed by a user during the user's content browsing experience; determining the context of the user's content browsing experience based on the parsed content and relationship data; retrieving targeted content that is associated with the determined context; presenting the targeted content to the user during the user's content browsing experience.

Determining the context of the user's content browsing experience based on the parsed content may include identifying one or more keywords in the parsed content and identifying the context associated with the one or more keywords.

The content accessed by user during the user's content browsing experience may be a description of an asset.

Presenting the targeted content to the user during the user's content browsing experience may include presenting the targeted content to a site that is different than the site that the content was accessed.

Presenting the targeted content to the user during the user's content browsing experience may include delivering the targeted content in a context that is external to the context of the accessed content.

The target content associated with a given asset may be delivered with a Really Simple Syndication (RSS) feed.

The context may include one or more of a location of the user's content browsing experience, a relationship between an initiating entity and a partner, a relationship between an initiating entity and an external entity, a relationship between the user and the initiating site, a source of the content, and an asset associated with the content.

The targeted content may include one or more of an advertisement associated with the determined context, a price link to a reseller site, a download.

Presenting the targeted content to the user during the user's content browsing experience may include displaying optimal pricing and commerce information for entities associated with the context.

The entities may include one or more of the user, an initiating site and an external site.

The method may also include receiving an indication from the user that the user wants to acquire an asset associated with the targeted content.

The user's browsing experience may include the user navigating among a plurality of web pages.

The content accessed by the user may be associated with a first web page of the plurality of web pages and the targeted content may be presented on a second web page of the plurality of web pages.

According to another aspect of the invention, a method for delivering targeted content comprising is provided. The method may include parsing content accessed by a user during the user's content browsing experience, the content describing an asset; determining the context of the user's content browsing experience based on the parsed content and relationship data; matching the context to a configurable value profiles stored in one or more of a financial data store, a CMS data store, a merchant management data store and an asset data store; and presenting targeted content associated with the matching configurable value profile during the user's content browsing experience.

Determining the context of the user's content browsing experience based on the parsed content may include identifying one or more keywords in the parsed content and identifying the context associated with the one or more keywords.

The content accessed by user during the user's content browsing experience may be a description of an asset.

The context may include one or more of a location of the user's content browsing experience, a relationship between an initiating entity and a partner, a relationship between an initiating entity and an external entity, a relationship between the user and the initiating site, a source of the content, and an asset associated with the content.

The method may also include receiving an indication from the user that the user wants to acquire an asset associated with the targeted content.

The user's browsing experience may include the user navigating among a plurality of web pages.

The content accessed by the user may be associated with a first web page of the plurality of web pages and the targeted content may be presented on a second web page of the plurality of web pages.

According to another aspect of the invention, a method for delivering targeted content is provided. The method includes receiving an output of a page crawl of a web page; receiving an output of a relationship database using data associated with the web page; determining a context of the web page based on the output of the page crawl and the output of the relationship database; identifying targeted content corresponding to the context of the web page; and transmitting the targeted content to the web page.

The context may include one or more of a location of the user's content browsing experience, a relationship between an initiating entity and a partner, a relationship between an initiating entity and an external entity, a relationship between the user and the initiating site, a source of the content, and an asset associated with the content.

The targeted content may include one or more of an advertisement associated with the determined context, a price link to a reseller site, a download and pricing information.

According to a further aspect of the invention, an apparatus for delivering targeted content is provided. The intelligent commerce module system includes a logic module configured to determine a context of the user's content browsing experience based on relationship data and parsed content of a web page and identify targeted content that is associated with the determined context; and a delivery module configured to monitor the content accessed by the user during the user's content browsing experience and transmit the content to the logic module, retrieve the targeted content from the logic module, and present the targeted content to the user during the user's content browsing experience.

The apparatus may also include a partner relationship data store and an asset data store, wherein the logic module is configured to access configurable value profiles in one or more of the partner relationship data store, asset data store and user data store to determine the context of the user's browsing experience and identify the targeted content.

The asset data store may include data for assets, commerce assets and asset to asset relationships.

The logic module may also identify an external website associated with the targeted content, and the delivery mechanism may also receive the accessed content from an initiating web site and present the target content associated with the external website to the user at the initiating website.

### BRIEF DESCRIPTION OF THE DRAWINGS

The accompanying drawings, which are incorporated in and constitute a part of this specification, exemplify the embodiments of the present invention and, together with the description, serve to explain and illustrate principles of the invention. The drawings are intended to illustrate major features of the exemplary embodiments in a diagrammatic manner. The drawings are not intended to depict every feature of actual embodiments nor relative dimensions of the depicted elements, and are not drawn to scale.

FIG. 1 is a block diagram of a system that provides a contextual based commerce experience in accordance with one embodiment of the invention;

FIG. 2 is a block diagram of an Intelligent Commerce Module in accordance with one embodiment of the invention;

FIG. 2A is a schematic diagram of interaction of the Intelligent Commerce Module with other system features in accordance with one embodiment of the invention;

FIG. 3 is a flow diagram of a method for providing a contextual based commerce experience in accordance with one embodiment of the invention;

FIG. 4 is a flow diagram of a method for providing a contextual based commerce experience in accordance with one embodiment of the invention;

FIG. 5 is a flow diagram of a method for providing a contextual based commerce experience in accordance with one embodiment of the invention;

FIG. 6 is a schematic drawing showing the intelligent commerce module on a web page in accordance with one embodiment of the invention;

FIG. 7 is a schematic drawing showing the intelligent commerce module on a web page in accordance with one embodiment of the invention; and

FIG. 8 is a block diagram of an exemplary computer system in accordance with one embodiment of the invention.

### DETAILED DESCRIPTION

Embodiments of the invention relate to a contextual based commerce experience that dynamically delivers contextually aware content. The contextual based commerce experience is provided by an intelligent commerce module that can be added to a website as, for example, a Really Simply Syndication (RSS) feed. The intelligent commerce module determines the context of a browsing experience by analyzing the content of the web page, business relationships associated with the website on which the intelligence commerce module is located and, optionally, user data. In one embodiment, the intelligent commerce module itself parses the web page to identify the content of the web page and identifies the business relationships of the website on which the intelligent commerce module is located. In another embodiment, the intelligent commerce module interacts with other system components which parse the web page content and contractual data and provides the content and business relationship data to the intelligent commerce module for further analysis. The intelligent commerce module then delivers content based on the context, as characterized by the content and relationship data. In other words, the intelligent commerce module provides a contextual based commerce experience by: (1) determining the context under which a user wishes to acquire an asset; (2) determining the context under which the asset is being offered; and, (3) delivering a buying experience appropriate for the user and the context under which the asset is being offered.

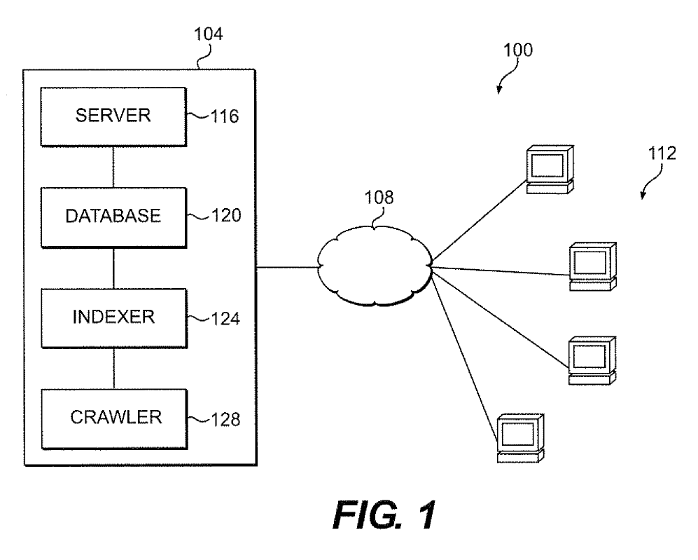

An embodiment of the invention will now be described in detail with reference to FIG. 1. FIG. 1 illustrates a system 100 for delivering the contextual based commerce experience. The system 100 includes a commerce system 104, a network 108 and a plurality of user systems 112. The commerce system 104 includes a server 116, a database 120, an indexer 124, and a crawler 128.

The commerce system 104 is connected to the plurality of user systems 112 over the network 108. The server 116 is in communication with the database 120 which is in communication with the indexer 124. The indexer 124 is in communication with the crawler 128. The crawler 128 is capable of communicating with at least some of the user systems 112 over the network 108.

The server 104 is typically a computer system, and may be an HTTP (Hypertext Transfer Protocol) server. The server 104 includes at least processing logic and memory. The indexer 124 is a software program which is used to create an index, which is then stored in storage media. The index is typically a table of alphanumeric terms with a pointer identifying the location of the alphanumeric terms. An exemplary pointer is a Uniform Resource Locator (URL). The indexer 124 may build a hash table, in which a numerical value is attached to each of the terms. The database 120 is stored in a storage media, which typically includes the information which is indexed by the indexer 124. The index may be included in the same storage media as the database 120 or in a different storage media. The storage media may be volatile or non-volatile memory that includes, for example, read only memory (ROM), random access memory (RAM), magnetic disk storage media, optical storage media, flash memory devices and zip drives. The crawler 128 is a software program or software robot, which is used to build lists of the information found on web pages. The crawler 128 searches web pages on the Internet and keeps track of the information located in its search and the location of the information.

The network 108 is a local area network (LAN), wide area network (WAN), a telephone network, such as the Public Switched Telephone Network (PSTN), an intranet, the Internet, or combinations thereof.

The plurality of user systems 112 may be mainframes, minicomputers, personal computers, laptops, personal digital assistants (PDA), cell phones, and the like. The plurality of user systems 112 are characterized in that they are capable of being connected to the network 108. The plurality of user systems 112 typically include web browsers and, optionally, may host web sites.

In use, the crawler 128 crawls websites to locate information on the web pages. The crawler 128 employs software robots to build lists of the information. The crawler 128 may include one or more crawlers to search the web. The crawler 128 typically extracts the information and stores it in the database 120. The indexer 124 creates an index of the information stored in the database 120. Alternatively, if a database 120 is not used, the indexer 124 creates an index of the information and where the information is located in the Internet (typically a URL).

When a user of one of the plurality of user systems 112 is browsing a web page, browsing information is communicated to the commerce system 104 over the network 108. For example, a signal is transmitted from one of the user systems 112, the signal having a destination address (e.g., address representing the commerce system), a request (e.g., commerce data request) and a return address (e.g., address representing user system that initiated the request). The server 116 accesses the database 120 to provide commerce data, which is communicated to the user over the network 108. For example, another signal may be transmitted that includes a destination address corresponding to the return address of the client system, and commerce data responsive to the request.

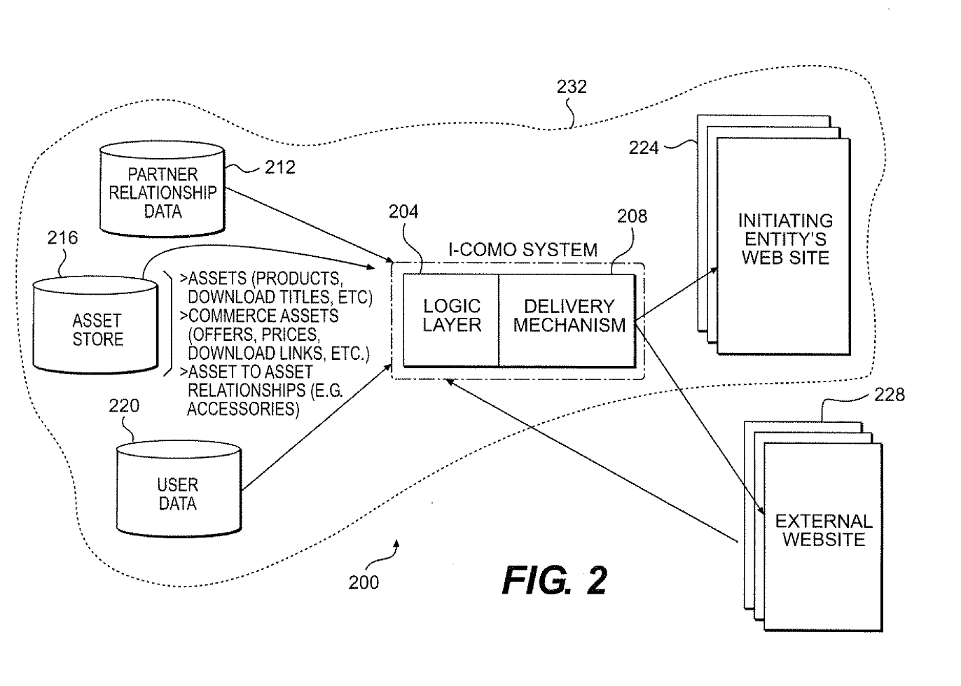

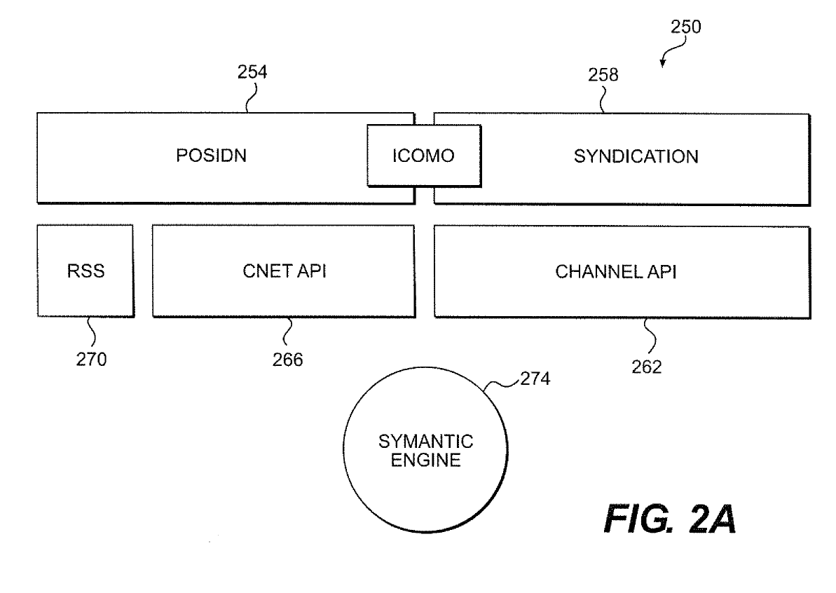

FIG. 2 illustrates the intelligent commerce module in further detail. The intelligent commerce module may be located at the commerce system 104. In FIG. 2, the intelligent commerce module 200 includes a logic layer 204 and a delivery mechanism 208. The logic layer 204 is in communication with a partner relationship data store 212, an asset store 216 and a user data store 220. The logic layer 204 may also interact with financial, content management system (CMS), and merchant management data stores. It will be appreciated that the logic layer 204 need not be in communication with each of the data stores 212-220 and may be in communication with additional data stores. In addition, it will be appreciated that each data store 212-220 may be divided into multiple data stores. An initiating entity's web site 224 is in communication with the delivery mechanism 208, and an external website 228 is in communication with both the logic layer 204 and the delivery mechanism 208.

The logic layer 204 is software that is configured to analyze the context of a user's browsing experience and identify targeted content corresponding with the context to transmit to the user. The logic layer 204 relates methods of acquiring the asset (e.g., a price link to a reseller site, download, etc.) to the asset in question, and allows that acquisition experience to be delivered externally on an asset by asset basis.

In one embodiment, the logic layer 204 analyzes a page scrape or page crawl to determine the content of the web page browsed by the user and analyzes relationship data from one or more relationship databases. The logic layer 204 determines the context of a user's browsing experience by parsing web pages and analyzes the results of the page crawl based on rules, such as word occurrence. The logic layer 204 also maintains awareness of the state of various entities (e.g., the initiating site, the user, the partner of the initiating site, the external site, etc.) by accessing, the partnership data store 212, asset data store 216 and/or user data store 220.

In one embodiment, the logic layer 204 matches the available data to configurable value profiles. In one embodiment, the configurable value profiles include several value indexes (e.g., a user value index, a relationship value index, a product value index, etc.) and one or more rules that define how to evaluate the several value indexes. In another embodiment, the value indexes are inputs to the configurable value profile which evaluates the data based on the rules stored in the configurable value profiles. The configurable value profile may also include rules or data for the targeted content that should be delivered based on the value index values and rules. An example of a configurable value profile is a premier relationship with a particular manufacturer in which one of the rules may provide that the value index for the relationship value for that particular manufacturer should be assigned a higher value or should be assigned more weight relative to the user value index and product value index. In one embodiment, the logic layer 204 analyzes the page data and relationship data according to a value index. The value index may be a function of the value to the user, the value to the customer and the value to the hosting site. The values can be easily modified without affecting the intelligent commerce module 200.

The logic layer 204 then determines targeted content appropriate to display based on the page content data, relationship data and, optionally, user data. The targeted content that the logic layer 204 identifies is based on the type of asset (for example, a product versus a download), the context in which the product is being viewed by the user (for example, within the site versus being served via an RSS feed), and the details of the relationship (for example, with the reseller in the case of an actual physical product). If configurable value profiles are used by the logic layer 204 in the analysis, content corresponding to the matching configurable value profile is delivered to the user. If a value index is used by the logic layer 204 to analyze the user's browsing experience, the content having the highest value experience is delivered to the user.

The logic layer 204 also allows for semi-automated change in content based on the data points. In one embodiment, the logic layer 204 analyzes the context of the user's browsing experience in real time. Alternatively, the logic layer 204 may analyze the context of the user's browsing experience at periodic intervals. For example, the logic layer 204 may analyze the context of the user's browsing experience every 5 minutes, 10 minutes, 15 minutes or at any other incremental value of time.

The partner relationship data store 212 includes data about various entity relationships. Exemplary entity relationships include partnerships, customers, joint ventures, distributors, resellers, retailers, etc. The partner relationship data store 212 may include contractual data, CMS data and the like.

The asset store 216 includes data about assets, commerce assets and asset to asset relationships. Exemplary assets include products, download titles, etc; exemplary commerce assets include offers, prices, download links, etc; and, exemplary asset to asset relationships include accessories, etc.

The user data store 220 includes data about the user. For example, users can provide information to the intelligent commerce module 200 or the website hosting the intelligent commerce module 200 about assets they already own, their service providers, demographic information (e.g., age, sex, residence, etc.), and the like. In another embodiment, users can use a service, such as TechTracker, which automatically tracks the software, services and components associated with the user's computer.

The initiating entity's web site 224 refers to a website being viewed by the user during the user's browsing experience. The initiating entity's website 224 also refers to the website that is hosting the intelligent commerce module 200 and to which the delivery mechanism 208 delivers the targeted content to the user. For example, an online entity (e.g. CNET, the initiating entity in the example) describes a product (a download title, actual product, etc) that the user is considering acquiring. The online entity provides an experience to allow the user to acquire the product (e.g., purchase at the online entity or link to a site that sells the asset), and somehow benefits monetarily from the transaction. When the experience that the online entity provides is a link to another website, the linked website is an external website 228. The owner of the external website 228 typically has a relationship with the owner of the initiating entity's website 224.

The delivery mechanism 208 is configured to deliver the targeted content to the user based on the analysis of the logic layer 204. The delivery mechanism 208 may be a Really Simple Syndication (RSS) feed, a Java Script Object Notation (JSON) feed, Application Programming Interface (API) or other web interface tool. The delivery mechanism 208 also receives information about the environment in which the commerce module is being viewed and transmits the data to the logic layer 204. For example, the delivery mechanism 208 may transmit a pointer identifying the web page to the logic layer 204, which can then access a database (e.g., database 120) with parsed content for that page. In another example, the delivery mechanism 208 may parse the page and transmit the parsed content to the logic layer, or the delivery mechanism 208 may transmit the page information to a page crawler which transmits its results directly to the logic layer 204 or the delivery mechanism 208.

The information transmitted to the website by the delivery mechanism 208 includes one or more of links to partner websites, advertisements for partner's products, pricing information, etc. The delivery mechanism 208 can, therefore, dynamically display the optimal pricing and/or other commerce information for all entities involved, including the user, the initiating site, and any external site.

In one embodiment, the delivery mechanism 208 is coupled with an advertisement serving engine (not shown). For example, the delivery mechanism 208 may transmit a request to the advertisement serving engine that identifies a category of advertisement. The advertisement serving engine may then transmit an advertisement in that category to the delivery mechanism 208 or directly to the website for display. Similarly, the delivery mechanism 208 may transmit a request to the advertisement serving engine that identifies a particular manufacturer or other entity for display on the website. The delivery mechanism 208 may also be coupled to a price comparison engine, logo engine and the like to transmit requests for pricing information, logos and the like and then provide the requested information to the website.

In use, the logic layer 204 scalarizes all of the data points (the context within which the acquisition is taking place, the available data about the user, and current status of relationships between the initiating entity and its partners) to identify targeted content to deliver to the user. The logic layer 204 renders proper behavior as a function of asset type, relationship of primary asset to other supporting assets, and context within which it is being viewed. The delivery mechanism 208 then delivers the best possible commerce experience for all entities involved in that context to the user during the user's browsing experience.

In one embodiment, the intelligent commerce module 200 is or includes an RSS feed or other web interface tool that can be added to any website (e.g., reseller site, blog site, etc.) to deliver a dynamic contextual commerce experience to user's browsing the site. In FIG. 2, the initiating entity's website also hosts the intelligent commerce module 200, as identified by dashed line 232. Thus, the logic layer 204 and the relationship data and asset data are stored together with the initiating entity's server, and can be modified by the initiating entity in accordance with changes in relationships, assets, etc. It will be appreciated that the intelligent commerce module 200 can also be located on a server that is separate from the server that is hosting the initiating entity's website. It will also be appreciated that the intelligent commerce module 200 can be located at a server that is independent of both the initiating entity's server and an external site's server, but that maintains data stores that include relationship data for the initiating entity and external site.

Users typically browse several websites and several webpages within each website during a user browsing experience. Each webpage has a particular context (e.g., content, entity relationships, etc.). For example, the website lifehacker.com has information on the web pages that indicates a technology context, and the context also has a relationship with an advertisement service or other asset/commerce-oriented service related to the context. Thus, for the website lifehacker.com that has a technology context, technology-oriented advertisements from the asset/commerce-oriented service would be presented to the user. In another example, if a user is browsing on the ESPN website in a blog related to scuba diving, the user is presented with information, such as advertisements, relating to waterproof watches provided by or manufactured by partners of ESPN (and not GPS enabled watches by a non-partner).

The intelligent commerce module system 200 may also include an external delivery mechanism. For example, users can drop products that they are interested in tracking into their personal sites, such as Yahoo or Google RSS enabled home pages, and blogs such as Engadget. In this example, the intelligent commerce module 200 can then deliver a link to that product or related products to the user.

The intelligent commerce module system 200 can interact with user data. For example, the system 200 can deliver compatibility alerts when, for example, a user has a printer in their “Got It” list, but is looking at an ink cartridge that is not compatible.

The intelligent commerce module system 200 can also maintain awareness of product life cycles. If a given product had prices at one time, but has not had prices for, for example, 60 days (or other time frames), then a message that the product appears to be end-of-life can be delivered to the user. Links to either updated versions of the product, or accessories, or both can be prioritized and delivered to the user.

The intelligent commerce module 200 provides several advantages. In one example, if an entity does not have a relationship with a particular manufacturer of a directly-only type product, in the current models, most links are simply product alerts which are not valuable to the user or the entity. With the intelligent commerce module 200, competitive cross-sell products can be displayed to users that are researching the manufacturer's products. If the manufacturer does not like that products are being cross-sold through the intelligent commerce module, the manufacturer can request to have a relationship with the entity to have links to the manufacturer's site instead.

In another example, some products that user's research are not sold directly as products; instead, a system that incorporates the product is purchasable by the user. For example, chipsets are often reviewed on technology websites, but the chipsets are not sold to users—a graphics card is actually purchasable by users. The intelligent commerce module 200 can identify graphics cards that have pricing information to display on the website based on the chipset reviews.

The intelligent commerce module 200 can also be used in situations in which there is a product-series relationship, but the products have different manufacturers. Exemplary product categories in which these situations commonly arise include: graphics cards, cell phones, motherboards and Internet access. For example, there are many cell phone reviews, but users often have difficulty determining which plan providers support which cell phones. The intelligent commerce module 200 can identify the relationships and present links and/or advertisements that are particular to plan providers and cell phones associated with each plan provider.

The intelligent commerce module system 200 can also be used with products that are sold directly. For example, in prior art systems, if the manufacturer is not a partner, flat text is typically displayed in the price box. The intelligent commerce module 200 can instead connect to an advertisement system or database to display advertisements and/or links to competitive products that do have pricing information. If the manufacturer does not like that competitive advertisements are displayed, the manufacturer can then contact the commerce service provider to add a link to their site.

Because the intelligent logic layer 204 is a configurable layer that is aware of asset types, page types, and context, the most valuable behavior can be defined. The system is therefore able to use the available supporting features to offer the best experience to the user. The intelligent commerce module 200 is also a responsive commerce system in the sense that it automatically adjusts to the changing relationships of the entities involved. In contrast, current models are non-responsive, delivering the same experience even after relationships change. In addition, the pricing/commerce component is hard coded, or otherwise served through a system that does not interact with its environment.

The intelligent commerce module 200 can deliver pricing and data relationships, on a product by product basis, into every corner of the web on each site that has an intelligent commerce module 200. In addition, because the intelligent commerce module 200 can consider information such as the life cycle of products and user awareness, external sites will also use the intelligent commerce module 200 at their sites.

FIG. 2A illustrates a schematic logic architecture 250 showing integration of the intelligent commerce module system 200 with a product recommendation system according to an embodiment of the invention. It will be appreciated that the arrangement of the components and the types of components shown in FIG. 2A and described below may vary.

As shown in FIG. 2A, the logic architecture 250 includes a first data layer that includes Posidn 254 and syndication 258, a second delivery layer that includes channel API 262, CNET API 266 and RSS 270, and a symantic engine 274. In FIG. 2A, the intelligent commerce module 200 overlaps Posidn 254 and syndication 258. The logic architecture 250 may also be coupled to an accessory discovery engine (not shown) that provides information about accessories to products to the symantic engine 274. It will be appreciated that in the embodiment shown in FIG. 2A, the intelligent commerce module 200 may include only the logic layer 204 and use the delivery layer (e.g., channel API 262, CNET API 266 and/or RSS 270) or both the logic layer 204 and the delivery mechanism 208 to deliver the targeted content. Furthermore, it will be appreciated that although certain features in FIG. 2A are described with reference to CNET, the intelligent commerce module can be used in a logic architecture that is not affiliated with CNET.

Posidn 254 is configured to store business logic and control, for example, entitlement of syndication content, content ingestion rules, and other business logic. In one embodiment, Posidn 254 interacts with the intelligent commerce module 200 to make sure content does not get displayed in a manner inconsistent with syndication contracts that have a relationship with the host.

Syndication 258 is configured to receive data from various sources that syndicate data feeds (e.g., RSS, JSON, etc.). Exemplary sources include product review websites, commerce websites, product manufacturers, product suppliers and so on that have a relationship with the host.

The channel API 262 is configured to provide access to various data channels. For example, CNET offers channels related to product reviews, product cross-sell information, product datasheets, product accessories and the like.

The CNET API 266 includes data for tech and consumer electronics products such as computers, digital cameras, MP3 players, and TVs, as well as software titles and merchant pricing from CNET Certified Merchants and is configured for integration with external websites using, for example, the XML and JSON response formats.

The RSS 270 is a feed to deliver updated content to external websites. It will be appreciated that other feeds may be used such as JSON.

The symantic engine 274 is configured to parse contractual relationships, generate relationship profiles, recognize relationships between contextual entities, define asset relationships, apply rules in surrounding mechanisms, scalarize data, process rules to generate a recommendation, pull products to be displayed, parse websites, provide rules and relevant data to the intelligent commerce module 200 and the like. The symantic engine 274 may access various features of the system architecture 250 to identify relationships between contextual entities by parsing the data. The identified relationships can be delivered to a CMS data system, a front end of the website and/or the intelligent commerce module 200. The intelligent commerce module 200 then analyzes the data received from the symantic engine 274 to identify the targeted content to deliver to the user.

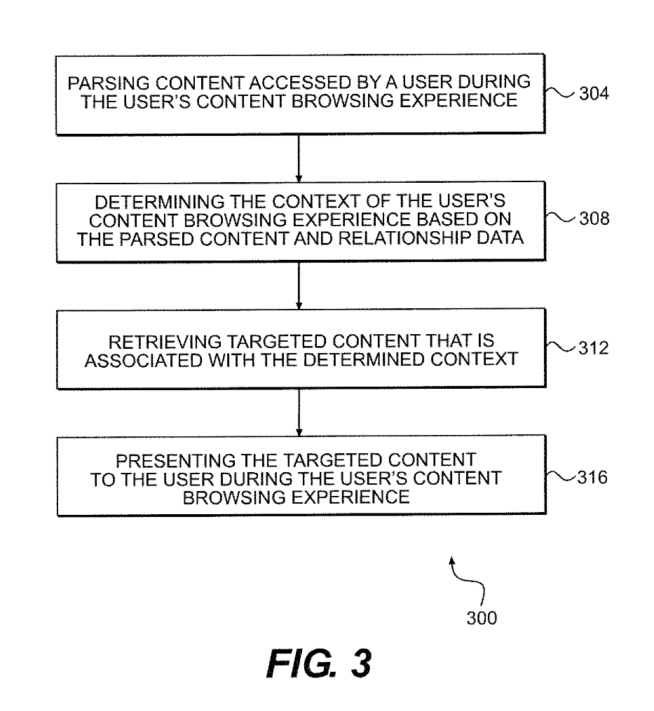

FIG. 3 illustrates a process 300 for providing a contextual based commerce experience in accordance with one embodiment of the invention. It will be appreciated that the process 300 described below is merely exemplary and may include a fewer or greater number of steps, and that the order of at least some of the steps may vary from that described below.

The process 300 begins by parsing content accessed by a user during the user's content browsing experience (block 304). For example, with reference to FIG. 1, the crawler 128 can parse the content of the web page that is accessed by the user. It will be appreciated that the crawler 128 can crawl the web page before the user accesses the web page or when the user accesses the web page (i.e., in real time).

The process 300 continues by determining the context of the user's content browsing experience based on the parsed content and relationship data (block 308). For example, with reference to FIG. 2, the logic layer 204 can determine the context by analyzing the parsed content and accessing the data stores 212-220. A value index can be used to determine the context by assigning values to the contextual data (e.g., content, relationship data, etc.) and applying rules to analyze the values.

Referring again to FIG. 3, the process 300 continues by retrieving targeted content that is associated with the determined context (block 312). For example, the logic layer 204 can access information in the asset store 216, as shown in FIG. 2, and/or an advertisement database to be transmitted to the user based on the context. In one embodiment, content corresponding to the highest index value is retrieved.

The process 300 continues by presenting the targeted content to the user during the user's content browsing experience (block 316). For example, the delivery mechanism 208 transmits the targeted content to the website through the RSS feed for display on the web page.

For example, BestBuy may have a relationship with Intel to display the Core 2 logo with certain products that include the Core 2 processor such as Sony computers. CNET may also have a relationship with Best Buy to advertise Best Buy. If another entity, such as a technology blog that is discussing Sony products, has the intelligent commerce module on their website, the intelligent commerce module may deliver the Core 2 logo and BestBuy logo together with an advertisement for a Sony computer being sold at BestBuy to the entity's website because of the relationships between CNET, BestBuy and Intel and because the user is browsing a blog about Sony products. The intelligent commerce module may also provide real time pricing of the Sony computer on the entity's website.

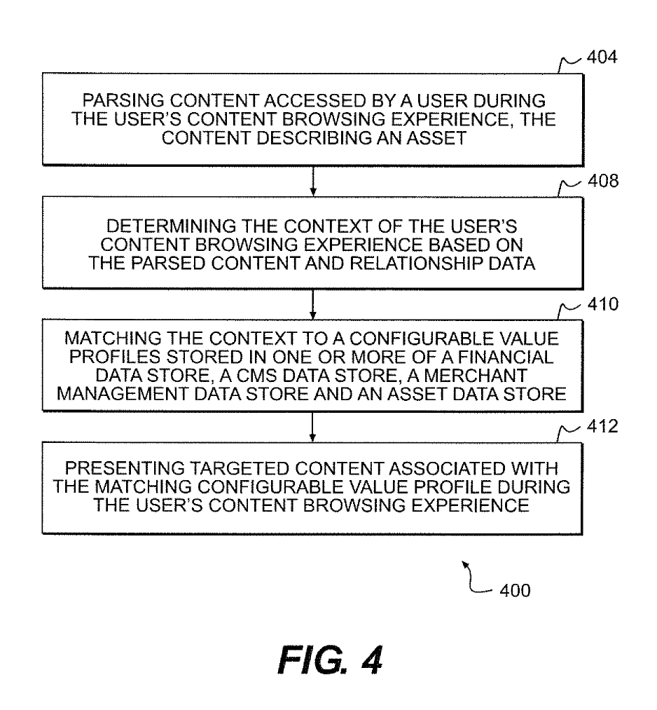

FIG. 4 illustrates a process 400 for providing a contextual based commerce experience in accordance with one embodiment of the invention. It will be appreciated that the process 400 described below is merely exemplary and may include a fewer or greater number of steps, and that the order of at least some of the steps may vary from that described below.

The process 400 begins by parsing content accessed by a user during the user's content browsing experience (block 404). For example, with reference to FIG. 1, the crawler 128 can transform the data representing the the content of the web page that is accessed by the user by selecting specific portions of the data. It will be appreciated that the crawler 128 can crawl the web page before the user accesses the web page or when the user accesses the web page (i.e., in real time).

The process 400 continues by determining the context of the user's content browsing experience based on the parsed content and relationship data (block 408). For example, with reference to FIG. 2, the logic layer 204 can determine the context by analyzing the parsed content and accessing the data stores 212-220. A value index can be used to determine the context by transforming the contextual data to assigned values (e.g., content, relationship data, etc.) and applying rules to analyze the values.

The process 400 continues by matching the context to a configurable value profile (block 412). For example, the logic layer 204 may access data stored in one or more of a financial data store, a CMS data store, a merchant management data store and an asset data store and transform the data by assigning value indexes to the context based on the accessed data. The value indexes can then be evaluated using one or more rules associated with the configurable value profile.

The process 400 continues by presenting targeted content associated with the matching configurable value profile during the user's content browsing experience (block 416). For example, the logic layer 204 can access information in the asset store 216, as shown in FIG. 2, and/or an advertisement database to be transmitted to the user based on the context. In one embodiment, content corresponding to the highest index value is retrieved. For example, the delivery mechanism 208 transmits the targeted content to the website through the RSS feed for display on the web page. Accordingly, the page to be viewed by the user has been transformed to a page of content that is relevant to the user.

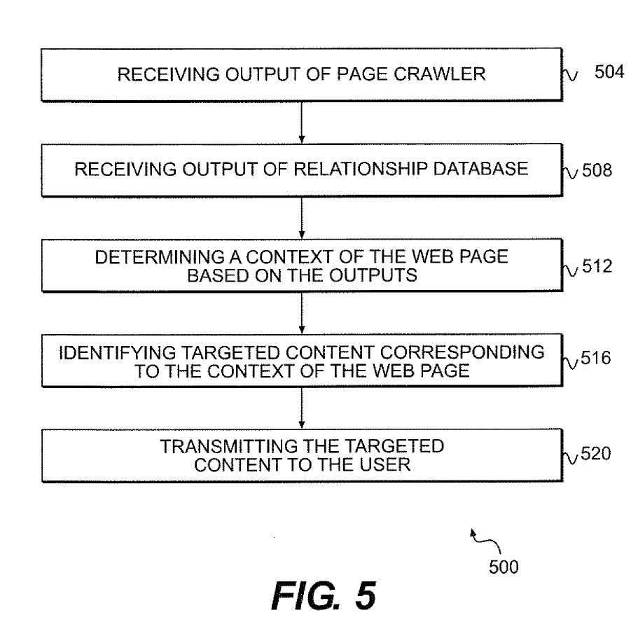

FIG. 5 illustrates a process 500 for providing a contextual based commerce experience in accordance with one embodiment of the invention. It will be appreciated that the process 500 described below is merely exemplary and may include a fewer or greater number of steps, and that the order of at least some of the steps may vary from that described below.

The process 500 begins by receiving the output of a page crawler (block 504). For example, with reference to FIG. 1, the crawler 128 can parse the content of the web page that is accessed by the user. It will be appreciated that the crawler 128 can crawl the web page before the user accesses the web page or when the user accesses the web page (i.e., in real time). The server 100 for example can provide the results of the crawler 128 to the logic layer 204 of the intelligent commerce module 200.

The process 500 continues by receiving the output of a relationship database (block 508). For example, with reference to FIG. 2, the logic layer 204 can access the data stores 212-220 to identify data in the data stores 212-220 corresponding to the user's commerce experience.

The process 500 continues by determining a context of the web page (block 512). For example, a value index can be used to determine the context by assigning values to the contextual data (e.g., content, relationship data, etc.) and applying rules to analyze the values.

The process 500 continues by identifying targeted content corresponding to the context (block 516). For example, the logic layer 204 can access information in the asset store 216, as shown in FIG. 2, and/or an advertisement database to be transmitted to the user based on the context. In one embodiment, content corresponding to the highest index value is retrieved.

The process 500 continues by transmitting the targeted content to the user (block 520). For example, the delivery mechanism 208 transmits the targeted content to the website through the RSS feed for display on the web page.

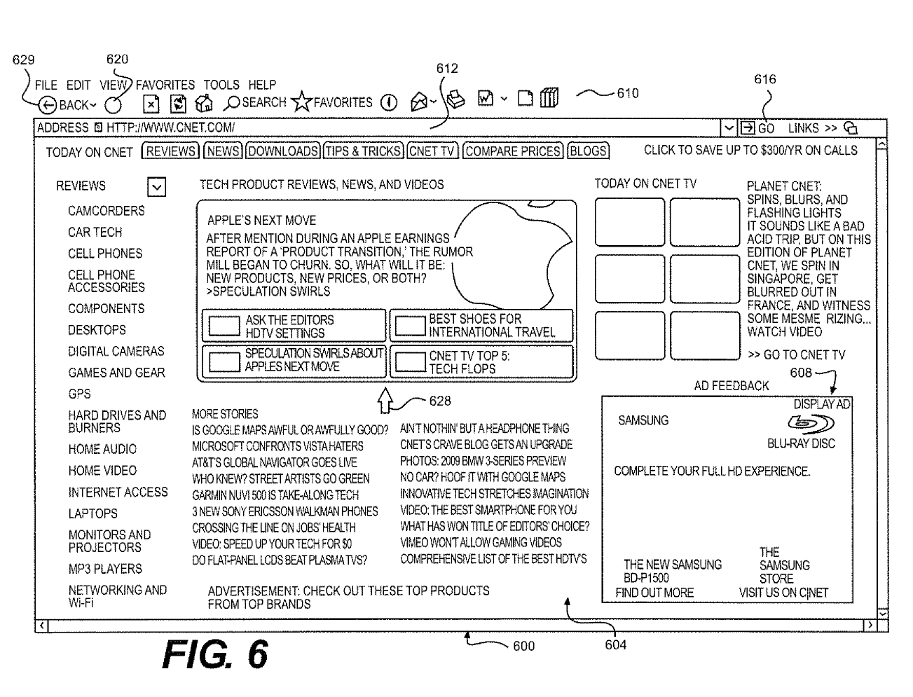

FIG. 6 illustrates an exemplary screen shot 600 of a web page 604 having an intelligent commerce module region 608. The web page 604 may be accessed using an Internet browser 610, which includes an address box 612, a “Go” button 616, forward and backward buttons 620, 624 and a pointer 628. A user can access the web page 604 with the Internet browser 610 by entering an Internet address box 612 or by selecting a link on another page (not shown) using the pointer 628 that directs the user to the web page 604. The user can also navigate between pages using the forward and backward buttons 620, 624.

The intelligent commerce module region 608 receives content from the delivery mechanism 208 of the intelligent commerce module 200, and displays the content on the web pages of the website that is hosting the intelligent commerce module 200. Because each webpage typically has different content, each webpage typically has different content displayed in the intelligent commerce module region 608. The content displayed in the intelligent commerce module region 608 includes, for example, advertisements, links to external websites, pricing information and other commerce information, and combinations thereof.

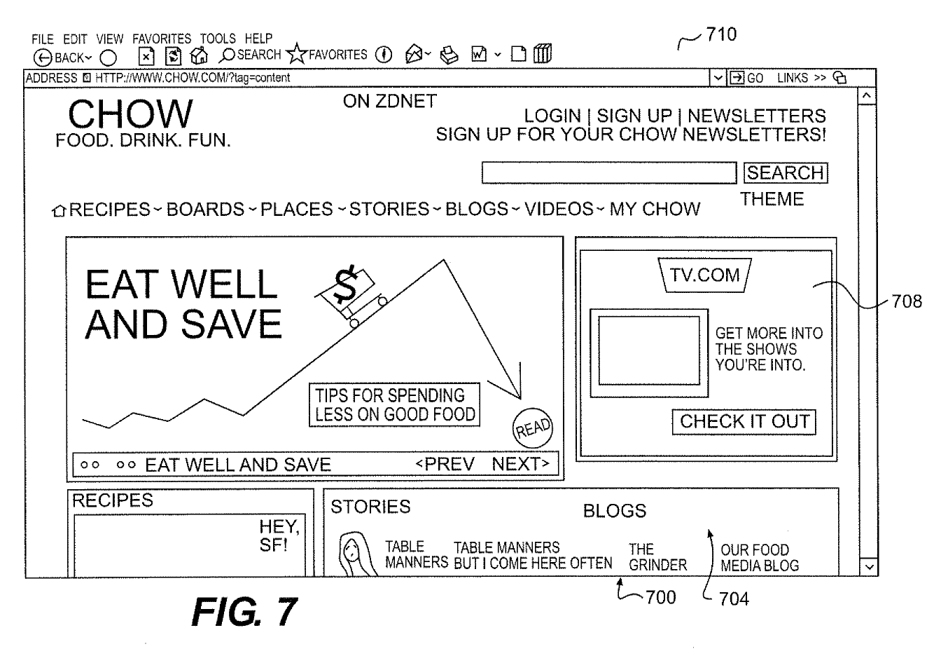

FIG. 7 illustrates an exemplary screen shot 700 of a web page 704 having an intelligent commerce module region 708. The web page 704 is also accessed by and displayed in a web browser 710, as described above with reference to FIG. 6. The intelligent commerce module region 708 also displays content according to the context of the web page 704.

As shown in FIGS. 6 and 7, because the web pages 604, 704 are directed to different content and are hosted by different websites having different owners, the content displayed in the respective intelligent commerce module regions 608, 708 is different. It is contemplated, however, that different web pages may also have the same targeted content displayed in the intelligent commerce module regions 608, 708.

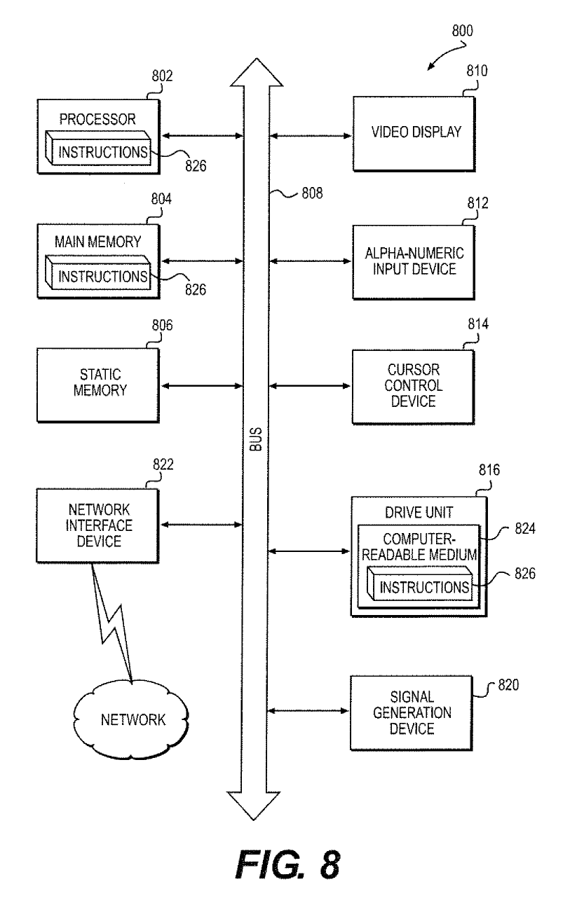

FIG. 8 shows a diagrammatic representation of machine in the exemplary form of a computer system 800 (or computing device) within which a set of instructions, for causing the machine to perform any one or more of the methodologies discussed herein, may be executed. In alternative embodiments, the machine operates as a standalone device or may be connected (e.g., networked) to other machines. In a networked deployment, the machine may operate in the capacity of a server or a client machine in server-client network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The exemplary computer system 800 includes a processor 802 (e.g., a central processing unit (CPU), a graphics processing unit (GPU) or both), a main memory 804 (e.g., read only memory (ROM), flash memory, dynamic random access memory (DRAM) such as synchronous DRAM (SDRAM) or Rambus DRAM (RDRAM), etc.) and a static memory 806 (e.g., flash memory, static random access memory (SRAM), etc.), which communicate with each other via a bus 808.

The computer system 800 may further include a video display unit 810 (e.g., a liquid crystal display (LCD) or a cathode ray tube (CRT)). The computer system 800 also includes an alphanumeric input device 812 (e.g., a keyboard), a cursor control device 814 (e.g., a mouse), a disk drive unit 816, a signal generation device 820 (e.g., a speaker) and a network interface device 822.

The disk drive unit 816 includes a machine-readable medium 824 on which is stored one or more sets of instructions (e.g., software 826) embodying any one or more of the methodologies or functions described herein. The software 826 may also reside, completely or at least partially, within the main memory 804 and/or within the processor 802 during execution thereof by the computer system 800, the main memory 804 and the processor 802 also constituting machine-readable media.

The software 826 may further be transmitted or received over a network 828 via the network interface device 822.

While the machine-readable medium 824 is shown in an exemplary embodiment to be a single medium, the term “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing, encoding or carrying a set of instructions for execution by the machine and that cause the machine to perform any one or more of the methodologies of the present invention. The term “machine-readable medium” shall accordingly be taken to include, but not be limited to, solid-state memories, optical and magnetic media, and carrier wave signals.

The computer system 800 is capable of transforming data which represents a physical entity, a rendered display of content or the like. Furthermore, the computer system 800 is capable of displaying the data or transmitting data for display on another computer system. For example, in the embodiments described above, the computer system 800 is capable transforming at least user browsing content on a web page and relationships between various entities into commercial information, such as pricing, advertisements and the like. Similarly, the computer system 800 is capable of displaying the commercial information on a web page and may transmit the commercial information to another computer system for display on the other computer system.

It should be understood that processes and techniques described herein are not inherently related to any particular apparatus and may be implemented by any suitable combination of components. Further, various types of general purpose computer devices may be used in accordance with the teachings described herein. It may also prove advantageous to construct specialized apparatus to perform the method steps described herein. The present invention has been described in relation to particular examples, which are intended in all respects to be illustrative rather than restrictive. Those skilled in the art will appreciate that many different combinations of hardware, software, and firmware will be suitable for practicing the present invention. The computer devices can be PCs, handsets, servers, PDAs or any other device or combination of devices which can carry out the disclosed functions in response to computer readable instructions recorded on media. The phrase “computer system”, as used herein, therefore refers to any such device or combination of such devices

The present invention has been described in relation to particular examples, which are intended in all respects to be illustrative rather than restrictive. Those skilled in the art will appreciate that many different combinations of hardware, software, and firmware will be suitable for practicing the present invention. Moreover, other implementations of the invention will be apparent to those skilled in the art from consideration of the specification and practice of the invention disclosed herein. Various aspects and/or components of the described embodiments may be used singly or in any combination. It is intended that the specification and examples be considered as exemplary only, with a true scope and spirit of the invention being indicated by the following claims.

What is claimed is:

1. A computer-implemented method for delivering targeted content comprising:
parsing content accessed by a user during the user's content browsing experience;
determining the context of the user's content browsing experience based on the parsed content and relationship data;
retrieving targeted content that is associated with the determined context;
presenting the targeted content to the user during the user's content browsing experience.

2. The method of claim 1, wherein determining the context of the user's content browsing experience based on the parsed content comprises identifying one or more keywords in the parsed content and identifying the context associated with the one or more keywords.

3. The method of claim 1, wherein the content accessed by user during the user's content browsing experience is a description of an asset.

4. The method of claim 1, wherein presenting the targeted content to the user during the user's content browsing experience comprises presenting the targeted content to a site that is different than the site that the content was accessed.

5. The method of claim 1, wherein presenting the targeted content to the user during the user's content browsing experience comprises delivering the targeted content in a context that is external to the context of the accessed content.

6. The method of claim 5, wherein the target content associated with a given asset is delivered with a Really Simple Syndication (RSS) feed.

7. The method of claim 1, wherein the context comprises one or more of a location of the user's content browsing experience, the user, the content of the page, a relationship between an initiating entity and a partner, a relationship between an initiating entity and an external entity, a relationship between the user and the initiating site, a source of the content, and an asset associated with the content.

8. The method of claim 7, wherein the relationship between the initiating entity and the partner and the relationship between the initiating entity and the external entity are identified by analyzing contractual data.

9. The method of claim 1, wherein the targeted content comprises one or more of an advertisement associated with the determined context, a price link to a reseller site, a download and pricing information.

10. The method of claim 1, wherein presenting the targeted content to the user during the user's content browsing experience comprises displaying optimal pricing and commerce information for entities associated with the context.

11. The method of claim 10, wherein the entities comprise one or more of the user, an initiating site and an external site.

12. The method of claim 1, further comprising receiving an indication from the user that the user wants to acquire an asset associated with the targeted content.

13. The method of claim 1, wherein the user's browsing experience comprises the user navigating among a plurality of web pages.

14. The method of claim 13, wherein the content accessed by the user is associated with a first web page of the plurality of web pages and wherein the targeted content is presented on a second web page of the plurality of web pages.

15. A computer-implemented method for delivering targeted content comprising:
identifying content accessed by a user during the user's content browsing experience, the content describing an asset;
identifying relationship data;
matching the content and relationship data to a configurable value profile; and
presenting targeted content associated with the matching configurable value profile during the user's content browsing experience.

16. The method of claim 15, wherein matching the content and relationship data to the configurable value profile comprises assigning a value index to the content, assigning a value index to the relationship data and evaluating the value index of the content and the value index of the relationship data using one or more rules.

17. The method of claim 15, wherein identifying content accessed by the user comprises parsing the content and identifying one or more keywords in the parsed content.

18. The method of claim 15, wherein configurable value profile is configured to analyze one or more of a location of the user's content browsing experience, the user, the content of the page, a relationship between an initiating entity and a partner, a relationship between an initiating entity and an external entity, a relationship between the user and the initiating site, a source of the content, and an asset associated with the content.

19. The method of claim 15, further comprising receiving an indication from the user that the user wants to acquire an asset associated with the targeted content.

20. The method of claim 15, wherein the user's browsing experience comprises the user navigating among a plurality of web pages.

21. The method of claim 20, wherein the content accessed by the user is associated with a first web page of the plurality of web pages and wherein the targeted content is presented on a second web page of the plurality of web pages.

22. A computer-implemented method for delivering targeted content comprising:
accessing a keyword database that includes keywords associated with a web page;
accessing a relationship database that includes relationship data associated with the web page;
determining a context of the web page based on the keywords associated with the web page accessed from the keyword database and the relationship data accessed from the relationship database;
identifying targeted content corresponding to the context of the web page; and
transmitting the targeted content to the web page.

23. The method of claim 22 wherein the relationship data comprises contractual data.

24. The method of claim 22 wherein the keyword database is compiled by a page crawler and indexer.

25. The method of claim 22 wherein the context comprises one or more of a location of the user's content browsing experience, a relationship between an initiating entity and a partner, a relationship between an initiating entity and an external entity, a relationship between the user and the initiating site, a source of the content, and an asset associated with the content.

26. The method of claim 22 wherein the targeted content comprises one or more of an advertisement associated with the determined context, a price link to a reseller site, a download and pricing information.

27. A computer system for delivering targeted content comprising:
a logic module configured to determine a context of a user's content browsing experience based on parsed content from the user's content browsing experience and relationship data, and identify targeted content that is associated with the determined context; and
a delivery module configured to monitor the content accessed by the user during the user's content browsing experience and transmit the content to the logic module, retrieve the targeted content from the logic module, and present the targeted content to the user during the user's content browsing experience.

28. The computer system of claim 27, further comprising:
a partner relationship data store;
an asset data store; and
wherein the logic module is further configured to access configurable value profiles in one or more of the partner relationship data store and asset data store to determine the context of the user's browsing experience and identify the targeted content.

29. The computer system of claim 28, wherein the asset data store comprises data for assets, commerce assets and asset to asset relationships.

30. The computer system of claim 27, wherein the logic module is further to identify an external website associated with the targeted content, and wherein the delivery mechanism is further to receive the accessed content from an initiating web site and present the target content associated with the external website to the user at the initiating website.

31. A machine readable medium containing computer executable instructions which cause a computer system to perform a method, the computer executable instructions comprising:
instructions for parsing content accessed by a user during the user's content browsing experience;
instructions for determining the context of the user's content browsing experience based on the parsed content and relationship data;
instructions for retrieving targeted content that is associated with the determined context;
instructions for presenting the targeted content to the user during the user's content browsing experience.

32. A machine readable medium containing computer executable instructions which cause a computer system to perform a method, the computer executable instructions comprising:
instructions for identifying content accessed by a user during the user's content browsing experience, the content describing an asset;
instructions for identifying relationship data;
instructions for matching the content and relationship data to a configurable value profile; and
instructions for presenting targeted content associated with the matching configurable value profile during the user's content browsing experience.

33. A machine readable medium containing computer executable instructions which cause a computer system to perform a method, the computer executable instructions comprising:
instructions for accessing a keyword database that includes keywords associated with a web page;
instructions for accessing a relationship database that includes relationship data associated with the web page;
instructions for determining a context of the web page based on the keywords associated with the web page accessed from the keyword database and the relationship data accessed from the relationship database;
instructions for identifying targeted content corresponding to the context of the web page; and
instructions for transmitting the targeted content to the web page.
